(19) United States
(12) Patent Application Publication
(10) Pub. No.: US 2024/0134087 A1
(43) Pub. Date: Apr. 25, 2024

(54) BLAST HEAVE MODELING UTILIZING ENERGY PARTITIONING

(71) Applicant: Dyno Nobel Inc., Salt Lake City, UT (US)

(72) Inventors: Charles Michael Lownds, Salt Lake City, UT (US); A B M Abdul Ali Bhuiyan, Salt Lake City, UT (US); Dale S. Preece, Saratoga Springs, UT (US)

(21) Appl. No.: 18/484,130

(22) Filed: Oct. 10, 2023

Related U.S. Application Data
(60) Provisional application No. 63/379,621, filed on Oct. 14, 2022.

(51) Int. Cl. G01V 99/00; F42D 3/04

(52) U.S. Cl. CPC G01V 99/005; F42D 3/04

(57) ABSTRACT

A blast modeling system may generate a site model based on blast input data. The blast input data may include blasthole data, bench information, and geology input data. The site model may comprise a plurality of distinct elements representing rock masses. The blast modeling system may simulate a blast by determine initial pressures in each blasthole caused by a detonation of an explosive. The blast modeling system may determine a heave of the blast based in part on the initial pressures, and display a simulation that is based in part on the heave.

### RELATED APPLICATIONS

This application claims priority to U.S. Provisional Application No. 63/379,621, filed Oct. 14, 2022, and titled “Blast Heave Modeling Utilizing Energy Partitioning,” which is hereby incorporated by reference in its entirety.

### TECHNICAL FIELD

The present disclosure relates generally to explosives. More specifically, the present disclosure relates to methods, systems, and apparatuses for designing a blast plan.

### BRIEF DESCRIPTION OF THE DRAWINGS

To easily identify the discussion of any particular element or act, the most significant digit or digits in a reference number refer to the figure number in which that element is first introduced.

FIG. 1 illustrates an advanced distinct element for blast simulations in accordance with one embodiment.

FIG. 2 illustrates an arc-to-arc contact detection technique that may be used by a modeling system to determine contact between arcs of neighboring elements in accordance with one embodiment.

FIG. 3 illustrates an arc-to-line contact detection technique in accordance with one embodiment.

FIG. 4 illustrates a way to detect line-to-line contact using the arc-to-line contact technique in accordance with one embodiment.

FIG. 5 illustrates a force calculation that a modeling system may use to determine a force applied to an advanced distinct element by contacting elements in accordance with one embodiment.

FIG. 6 illustrates a moment calculation to determine a moment applied to the advanced distinct element by contacting elements in accordance with one embodiment.

FIG. 7 illustrates a variety of potential element shapes in accordance with some embodiments.

FIG. 8 is a graph of an example adiabat for an explosion.

FIG. 9 illustrates a flow chart for a discrete element method in accordance with some embodiments.

FIG. 10 illustrates a simulation using GEM elements in accordance with some embodiments.

FIG. 11 is a chart that shows the surveyed bench and muck profile as well as the GEM predicted bench and muck profile in accordance with some embodiments.

FIG. 12 is a chart that illustrates consistency of the GEM predicted face velocities between simulations with circular and hexahedral elements in accordance with some embodiments.

FIG. 13 illustrates a blast modeled with both circular and hexagonal elements⋅in accordance with some embodiments.

FIG. 14 illustrates a model using GEM elements in accordance with some embodiments.

FIG. 15 illustrates a simulation of the model of FIG. 13 using energy partitioning in accordance with some embodiments.

FIG. 16 illustrates a mine model in accordance with some embodiments.

FIG. 17 illustrates a table of the four different explosives.

FIG. 18 shows a table that includes generic rock types used for the simulation of the model of FIG. 16.

FIG. 19 illustrates a table with example input variables for the simulation calculations for the model in FIG. 16 in accordance with some embodiments.

FIG. 20 illustrates a table of the calculated heave for four explosives in two rock types.

FIG. 21 illustrates a graph charting the effects of explosive and rock on cast.

FIG. 22 illustrates a graph showing the effect that rock type has on percent cast for ANFO.

FIG. 23 illustrates a graph of percent cast versus face velocity for two rock types.

### DETAILED DESCRIPTION

Explosives are commonly used in the mining, quarrying, and excavation industries for breaking rocks and ore. Generally, a hole, referred to as a “blasthole,” is drilled in a surface, such as the ground. Explosives may then be placed within the blasthole. Typically, multiple blastholes are used for breaking large amounts of rocks and ore. Using multiple blastholes introduces complexities for planning for a blast. For example, a blast may vary based on a plurality of factors including blasthole spacing, blasthole burden, blasthole depth, blasthole pattern, the number of blastholes, geological properties, the type of explosive, the amount of explosive, and the blasthole initiation time. The number of possibilities makes blast planning difficult, even for a highly trained blast engineer.

Blast simulations performed by modeling systems may be used to predict an outcome of a blast. Modeling systems simulate a blast to predict rock movement and blast induced heave. Blast modeling systems can be used to determine the location of ore in a final muck pile after a blast occurs to assist with ore management for waste ore disposal and minimization of mixing waste ore and target ore. Efficient blasting can be optimized in a specific rock by choosing the correct explosive based on the blast simulations. Explosive choice and pattern may be based on rock characteristics and desired blast outcomes in terms of fragmentation and heave.

Some blast modeling systems use distinct elements to simulate a blast. Distinct element modeling systems generate an assemblage of elements to represent a blast site and track the elements movement through time to simulate a blast. Individual element movement is caused by forces applied to the assemblage and usually also by gravity.

Some modeling systems use circular elements to represent rocks. An assemblage of two-dimensional circular elements moving through time due to explosive loading and gravity may be used to simulate a blast. Circles are very computationally efficient because interparticle contact can be determined by comparing the distance between the two circle centers with the sum of the radii of the circles. However, the circular elements oversimplify the rock masses which causes a loss in accuracy of the simulation. For example, circular elements do not generate friction between the elements or interact with one another the same way in which uneven rock masses would. Another challenge associated with spherical distinct elements is that they have no aspect ratio and are thus limited in the prediction of bulking or porosity creation in an assemblage of spherical distinct elements. Thus, the circular elements fail to accurately represent bulking that may occur in the final muck pile after the blast.

Some modeling systems employ straight-sided distinct elements such as quadrilateral elements or triangular elements to represent rock masses. A straight-sided distinct element is a series of lines connected to one another to form an outline of a shape with a set of angled corners. A system that uses straight-sided elements provides a more accurate simulation than a system that uses circular elements. For example, the straight-sided distinct elements can have aspect ratios unlike circular elements. However, detecting contact between straight-sided elements (e.g., contact between a corner of a first element and a side of a second element, contact between a corner of a second element and a side of a first element, and contact between a side of a first element and a side of a second element) is a very complex and computationally intensive process. Further, simulations using these types of distinct elements require orders of magnitude more computation time to complete than simulations employing spherical elements. Additionally, the straight-sided elements tend to be too stiff, bulk too much and not represent rock flow behavior very well.

Some embodiments herein use distinct elements with an advanced geometrical paradigm to represent blasted rock movement in a blast simulation. Geologic Element Motion (GEM) is a Discrete Element Method (DEM) capability for blast-induced heave simulation with a very fast computational algorithm that can efficiently treat many different element shapes. GEM elements (also referred to herein as advanced distinct elements) are created by utilizing alternating arcs and lines.

GEM elements geometrically comprise arcs and lines that define the outline of the individual distinct element. Each line is connected via the arcs such that the lines do not intersect. Instead, the arcs and lines are used to create a two-dimensional distinct element with one or more straight sides and rounded corners. The rounded corners may be formed with one or more arcs. These GEM elements improve the accuracy of a simulation when compared to the circular elements and are more computationally efficient than the straight-sided distinct elements.

Although complex GEM shapes are possible, blast modeling requires the elements to represent solid ground with a minimum of void in the element array. Thus, GEM blast heave models may be created from packable element shapes such as hexahedrons, quadrilaterals, pentagons, triangles, and circles. Hexahedrons, quadrilaterals, and circles may be utilized to represent blasted rock.

Some embodiments include the ability to define the size of the rounded corner radius as well the length of the sides for quadrilateral and hexahedral elements. Circles can be created from a quadrilateral element with zero length sides and four arcs.

Explosive gas loading of GEM elements may be accomplished by employing the Noble-Abel equation of state (EOS), which is unique to each explosive formulation. Noble-Abel EOS characteristics have been developed for forty different blasting-relevant explosive formulations. These formulations include ammonium nitrate/fuel oil (ANFO), AN-only emulsions, dual salt (AN+SN) emulsions and blends of ANFO with AN-only emulsions. Density is either unmodified (i.e., blends) or controlled by chemical gassing or micro balloons (plastic and glass).

Explosive simulations may calculate rock motion from a knowledge of the gas pressure moving the elements. The simulation may use an expression for the pressure vs volume, or the adiabat, of the explosion product gases. This work uses an analytical expression for the adiabat derived from the explosive's properties. The effect of the explosive detonation pressure in crushing an annulus of rock, and setting up a shock wave, may be termed Brisance. Some embodiments may incorporate a deleterious effect of Brisance on subsequent rock motion.

Some embodiments may employ energy partitioning between brisance, fragmentation, and heave. This physics-based partitioning may provide accurate modeling of blast results over a wide range of rock types and explosive types. It accurately defines the volumetric, pressure and energy state of the explosive gases in a blasthole following detonation. Rock mechanical properties and explosive characteristics may be included in the calculations. Additionally, some embodiments provide methods to better predict heave.

While many of the embodiments herein discuss energy partitioning in relation to discrete element modeling (e.g., GEM), the energy partitioning may be used in combination with other simulation techniques. For example, energy partitioning may be used in fragmentation modeling. The energy partitioning may be used to determine explosive energy, explosive type, and/or explosive density for a desired outcome.

It will be readily understood that the components of the embodiments as generally described below and illustrated in the Figures herein could be arranged and designed in a wide variety of different configurations. For instance, the steps of a method do not necessarily need to be executed in any specific order, or even sequentially, nor do the steps need to be executed only once. Thus, the following more detailed description of various embodiments, as described below and represented in the Figures, is not intended to limit the scope of the disclosure but is merely representative of various embodiments. While the various aspects of the embodiments are presented in the drawings, the drawings are not necessarily drawn to scale unless specifically indicated.

Embodiments and implementations of blast planning systems and methods described herein may include various steps, which may be embodied in machine-executable instructions to be executed by a computer system. A computer system may include one or more general-purpose or special-purpose computers (or other electronic devices). The computer system may include hardware components that include specific logic for performing the steps or may include a combination of hardware, software, and/or firmware.

Embodiments may be provided as a computer program product including a computer-readable medium having stored thereon instructions that may be used to program a computer system or other electronic device to perform the processes described herein. The computer-readable medium may include, but is not limited to: hard drives, floppy diskettes, optical disks, CD-ROMs, DVD-ROMs, ROMs, RAMs, EPROMs, EEPROMs, magnetic or optical cards, solid-state memory devices, or other types of media/computer-readable media suitable for storing electronic instructions.

Computer systems and the computers in a computer system may be connected via a network. Suitable networks for configuration and/or use as described herein include one or more local area networks, wide area networks, metropolitan area networks, and/or Internet or IP networks, such as the World Wide Web, a private Internet, a secure Internet, a value-added network, a virtual private network, an extranet, an intranet, or even stand-alone machines which communicate with other machines by physical transport of media. In particular, a suitable network may be formed from parts or entireties of two or more other networks, including networks using disparate hardware and network communication technologies.

One suitable network includes a server and several clients; other suitable networks may contain other combinations of servers, clients, and/or peer-to-peer nodes, and a given computer system may function both as a client and as a server. Each network includes at least two computers or computer systems, such as the server and/or clients. A computer system may include a workstation, laptop computer, disconnectable mobile computer, server, mainframe, cluster, so-called “network computer” or “thin client,” tablet, smart phone, personal digital assistant or other hand-held computing device, “smart” consumer electronics device or appliance, medical device, or a combination thereof.

Suitable networks may include communications or networking software, such as the software available from Novell®, Microsoft®, and other vendors, and may operate using TCP/IP, SPX, IPX, and other protocols over twisted pair, coaxial, or optical fiber cables; telephone lines; radio waves; satellites; microwave relays; modulated AC power lines; physical media transfer; and/or other data transmission “wires” known to those of skill in the art. The network may encompass smaller networks and/or be connectable to other networks through a gateway or similar mechanism.

Each computer system includes one or more processors and/or memory; computer systems may also include various input devices and/or output devices. The processor may include a general-purpose device, such as an Intel®, AMD®, or other “off-the-shelf” microprocessor. The processor may include a special-purpose processing device, such as an ASIC, SoC, SiP, FPGA, PAL, PLA, FPLA, PLD, or other customized or programmable device. The memory may include static RAM, dynamic RAM, flash memory, one or more flip-flops, ROM, CD-ROM, disk, tape, magnetic, optical, or other computer storage medium. The input device(s) may include a keyboard, mouse, touch screen, light pen, tablet, microphone, sensor, or other hardware with accompanying firmware and/or software. The output device(s) may include a monitor or other display, printer, speech or text synthesizer, switch, signal line, or other hardware with accompanying firmware and/or software.

The computer systems may be capable of using a floppy drive, tape drive, optical drive, magneto-optical drive, or other means to read a storage medium. A suitable storage medium includes a magnetic, optical, or other computer-readable storage device having a specific physical configuration. Suitable storage devices include floppy disks, hard disks, tape, CD-ROMs, DVDs, PROMs, RAM, flash memory, and other computer system storage devices. The physical configuration represents data and instructions which cause the computer system to operate in a specific and predefined manner as described herein.

Suitable software to assist in implementing the invention is readily provided by those of skill in the pertinent art(s) using the teachings presented here and programming languages and tools, such as Modern Fortran, Java, Pascal, C++, C, PHP, .Net, database languages, APIs, SDKs, assembly, firmware, microcode, and/or other languages and tools. Suitable signal formats may be embodied in analog or digital form, with or without error detection and/or correction bits, packet headers, network addresses in a specific format, and/or other supporting data readily provided by those of skill in the pertinent art(s).

Aspects of certain embodiments may be implemented as software modules or components. As used herein, a software module or component may include any type of computer instruction or computer executable code located within or on a computer-readable storage medium. A software module may, for instance, comprise one or more physical or logical blocks of computer instructions, which may be organized as a routine, program, object, component, data structure, etc., that performs one or more tasks or implement particular abstract data types. A particular software module may comprise disparate instructions stored in different locations of a computer-readable storage medium, which together implement the described functionality of the module. Indeed, a module may comprise a single instruction or many instructions, and may be distributed over several different code segments, among different programs, and across several computer-readable storage media.

Some embodiments may be practiced in a distributed computing environment where tasks are performed by a remote processing device linked through a communications network. In a distributed computing environment, software modules may be located in local and/or remote computer-readable storage media. In addition, data being tied or rendered together in a database record may be resident in the same computer-readable storage medium, or across several computer-readable storage media, and may be linked together in fields of a record in a database across a network. According to one embodiment, a database management system (DBMS) allows users to interact with one or more databases and provides access to the data contained in the databases.

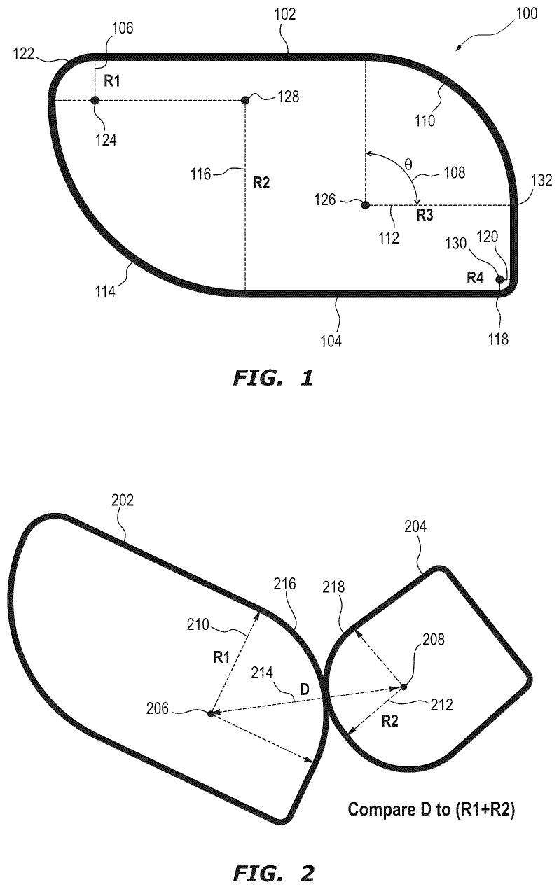

A new discrete element technique has been developed that overcomes the simplified behavior of circular elements, is considerably more efficient computationally than rectangular elements and exhibits flow behavior more representative of blasted rock. As illustrated in FIG. 1, a two-dimensional GEM element is created by enclosing space with a series of arcs and lines. It also shows the data structure for defining the lines and arcs constituting the element.

FIG. 1 illustrates an advanced distinct element 100 according to one embodiment. A distinct element modeling system segments using the advanced distinct element 100 segments a two-dimensional site model into a plurality of elements. The advanced distinct element 100 has a shape formed by connecting end points of one or more lines with arcs such that the end points of the two or more lines are indirectly coupled via the arcs and the arcs form rounded corners of the shape. The illustrated embodiment of the advanced distinct element 100 comprises a first line 102, a second line 104, and a third line 132 connected by four arcs (i.e., first arc 114, second arc 122, third arc 110, and fourth arc 118).

The illustrated embodiment includes two parallel lines. Other embodiments may feature one or more lines and the lines may be at an angle relative to one another. Each line comprises two end points, and each end point is connected to an arc such that the shape features rounded corners or edges. Each rounded corner may be created using one or more arcs. For example, one rounded corner or rounded edge is created by connecting the first arc 114 and the second arc 122.

Each arc is a differentiable curve. In the illustrated embodiment, the arcs are circular arcs that outline a part of a circumference of a circle. The illustrated embodiment includes four arcs. Other embodiments may include a different number of arcs. Each arc comprises an arc center point (i.e. first center point 126, second center point 128, third center point 130, and fourth center point 124). The arc center points represent a point equidistant from all points on the circular arc. Each arc further comprises a radius (i.e., first radius 112, second radius 116, third radius 120, and fourth radius 106). Because the arcs are circular, the radius for each arc is the same along all points of the arc. Additionally, each arc comprises an arc angle (e.g., third arc angle 108). The arc angle is the angle formed by the arc at the center point. As illustrated, end points of the arcs may connect to either another arc as shown by the connection between first arc 114 and the second arc 122, or the endpoints of the arcs may be connected to lines as shown by the connections between the first line 102 and the third arc 110.

The intersections between arcs and lines and the intersections between arcs and arcs form smooth transitions between the different shape outline elements. Each line may be tangential to the end point of the arc to which it is connected to smooth the transition. Similarly arc-to-arc transitions may smoothly transition. The intersections do not form sharp angles such as is formed when two straight lines directly connect and form a vertex. The resulting shape features an outline with rounded corners rather than a shape with angled corners. Thus, the lines of advanced distinct element 100 are not directly connected, but rather indirectly coupled via the arcs, to prevent the angled corners. The rounded corners are more computationally efficient than sharp angled corners and may be created using one or more arcs.

The advanced distinct element 100 is created from arcs and lines that define the outline of the individual distinct element. FIG. 1 illustrates one of the many possible element shapes that can be created from arcs and lines. Other embodiments of an advanced distinct element may use arcs and lines to create other non-spherical shapes without angled corners. Other shapes that may be created using a combination of arcs and lines include polygons with rounded corners such as a triangle with rounded corners, a trapezoid with rounded corners, a rectangle with rounded corners, a square with rounded corners, a hexagon with rounded corners, or an octagon with rounded corners.

In some embodiments, the shape used for elements of a simulation model may be based on geologic data such as rock hardness. In some embodiments, at least some of the elements are different shapes. For example, different types of rock may be modeled using different shapes of elements. For instance, coal may be modeled with a rounded quadrilateral and another rock in the same simulation may be modeled with a rounded hexahedron. In some embodiments, at least some of the elements of a same shape are different sizes.

The distinct element shapes formed with non-continuous lines indirectly coupled via arcs provide better accuracy than circular elements and provide a computational efficiency advantage over distinct elements with only straight lines. The straight lines and varying arc radiuses provide a more realistic aspect ratio when compared with circles, while the arcs provide a more efficient way to detect contacts between neighboring elements when compared to elements with only straight lines.

Each advanced distinct element 100 in a blast simulation model may be stored in memory of a modeling system. For example, the advanced distinct element 100 may be a data structure comprising line endpoint node coordinates, designated arc end points, arc center points, arc radiuses, and arc angles.

In some embodiments, the first step in the contact detection algorithm is a binning process that sorts GEM elements into square geometric regions or bins that are fixed in space. Detailed contact detection occurs for the elements by searching each bin and its neighbors for arc-to-arc and arc-to-line contacts. This bin sort method is highly efficient in searching for contact between elements because each bin only contains a few elements at any time.

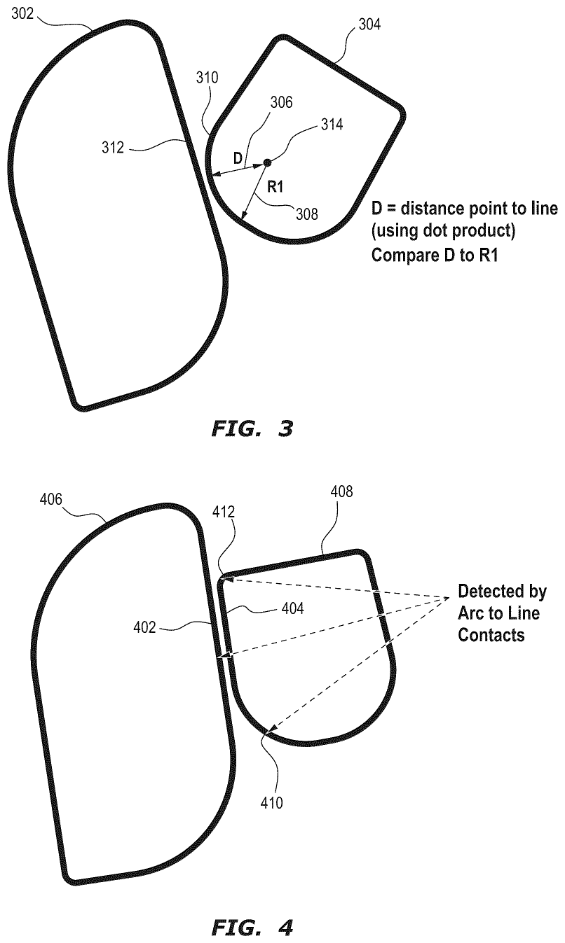

Contact detection and resolution of GEM elements with their neighbors is illustrated in FIG. 2 for a given pair of arcs as well as arc to line. This contact detection algorithm has the computational efficiency of circular elements.

Contact detection and resolution between the sides from two GEM elements is not necessary because it will be detected by previous arc-to-line contacts as illustrated in FIG. 2. This makes the GEM contact detection algorithm even more efficient.

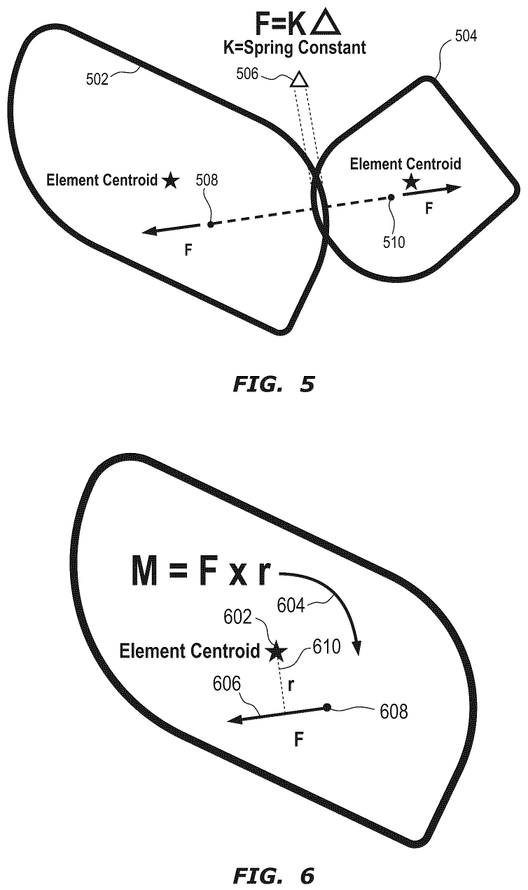

FIGS. 2-4 illustrate various ways to detect contact between advanced distinct elements. Two key inter-element interaction mechanisms for detecting contact between neighboring elements are arc-to-arc as illustrated in FIG. 2, and arc-to-line as illustrated in FIG. 3. Another possible interaction mechanism is line-to-line as illustrated in FIG. 4. However, as discussed in more detail below, the line-to-line contact may be detected by the arc-to-line interaction mechanisms.

Detecting these element interactions between the advanced distinct elements are all very computationally efficient, much more so than interactions between straight sided distinct elements. The advanced distinct elements also have aspect ratio greater than one with more natural bulking and inter-particle friction than circular elements.

The described advanced distinct elements will enable a simulation to increase fidelity in distinct element modeling of rock blasting because the elements have an aspect ratio that circular elements do not have and will naturally exhibit more of the natural behavior of rocks during blasting induced movement such as bulking, and inter-element friction.

Also, due to the computational simplicity and speed of arc-to-arc and arc-to-line contact detection and resolution, higher fidelity simulations can be completed with substantially less computation time. This implies that significantly more realistic blasting simulations can be accomplished on less expensive and more portable laptop computers.

FIG. 2 illustrates an arc-to-arc contact detection technique that may be used by a modeling system to determine contact between arcs of neighboring elements. As shown, a first element 202 with a first arc 216 is neighboring a second element 204 with a second arc 218.

To detect if the arcs of these two elements contact each other during a time step of a simulation, a modeling system may determine if there is an overlap between the first arc 216 and the second arc 218. Such overlapping arcs may be referred to as arc-to-arc contact. Detecting arc-to-arc contact between the neighboring elements comprises comparing a distance 214 between arc center points (i.e., first center point 206 and second center point 208) of the first arc 216 and the second arc 218 of the neighboring elements to a sum of a first radius 210 and a second radius 212 of the two arcs of the neighboring elements. For example, in some embodiments, arc-to-arc contact is detected when the sum of the radiuses is greater than the distance 214.

FIG. 3 illustrates an arc-to-line contact detection technique that may be used by a modeling system to determine contact between an arc 310 and a line 312 of neighboring elements. In this figure, the first element 302 and the second element 304 are neighboring elements where the nearest points along the perimeters of the elements are the arc 310 of the second element 304 and the line 312 of the first element 302. R1 represents the radius 308 of the arc 310 and D represents a shortest distance 306 between an arc center point 314 and the line 312. A modeling system may determine the distance 306 using the dot product.

When the arc 310 and a line 312 overlap in the simulation it is referred to as arc-to-line contact. A modeling system may detect arc-to-line contact between the neighboring elements by comparing a radius 308 of the arc 310 to a distance 306 between the line 312 of a first element 302 and an arc center point 314 of the arc 310 of the second element 304. For example, contact may be detected when the radius 308 is greater than the distance 306.

FIG. 4 illustrates how a line-to-line contact may be detected by a modeling system using the arc-to-line contact technique described with reference to FIG. 3. Line-to-line contact occurs when a first line 402 of a first element 406 overlaps with a second line 404 of a second element 408. Direct line-to-line contact detection is computationally less efficient than arc-to-arc contact detection and arc-to line contact detection. Therefore, in some embodiments, line-to-line contact may be detected indirectly using the arc-to-line contact detection technique because when the lines overlap, one or both of the first arc 410 and the second arc 412 will overlap the first line 402.

Thus, to determine the neighboring element contact a modeling system may the use arc-to-line contact technique described with reference to FIG. 3 on one or both of the first arc 410 and the second arc 412. For example, the system may compare a radius of the first arc 410 to a distance between the first line 402 and a center point of the first arc 410 and compare a radius of the second arc 412 to a distance between the first line 402 and a center point of the second arc 412.

FIG. 5 illustrates a force calculation that a modeling system may use to determine a force applied to an advanced distinct element by contacting elements. The modeling system may calculate the magnitude and direction of the forces applied to each element. The system detects contact between the first element 502 and the second element 504 when there is an overlap 506 of the perimeters of the two distinct elements during a time step of a simulation. The modeling system resolves or eliminates the overlap by applying restoring forces that are calculated to eliminate the overlap 506. These restoring forces are applied to both the first element 502 and the second element 504.

As part of a simulation, a modeling system may determine contact and calculate a force to apply to each element by a contacting neighbor element. The force is calculated based on the overlap 506 caused by the contact. For arc-to-arc contact, the force is applied through the arc center points (i.e., first arc center point 508 and second arc center point 510) for arc-to-arc contact. For arc-to-line contact, the force is applied perpendicular to the line and through a center of the arc. The magnitude of this restorative force (F) is equal to the specified spring constant (K) of the material multiplied by the overlap 506 (A). As depicted in FIG. 5, F=KA.

FIG. 6 illustrates a moment calculation that a modeling system may use to determine a moment 604 applied to the advanced distinct element 600 by contacting elements. Each force 606 applied to the advanced distinct element 600 will also produce a moment 604, M, on the advanced distinct element 600 as illustrated. Moments are applied to the element center 602 by all of the forces applied to the advanced distinct element 600 including the force 606 applied to the arc center point 608 caused by contacting elements. In some embodiments, the modeling system calculates a moment for each force separately and then sums the moments to determine a total moment for the advanced distinct element 600.

A modeling system may calculate the moment 604 by calculating:

M=F×r Equation 1
Where:
F is the force 606; and
r 610 is the shortest distance between a vector representing the force 606 and the element center 602.

The total moment (i.e., the sum of the moments) is calculated to determine the rotation of the advanced distinct element 600.

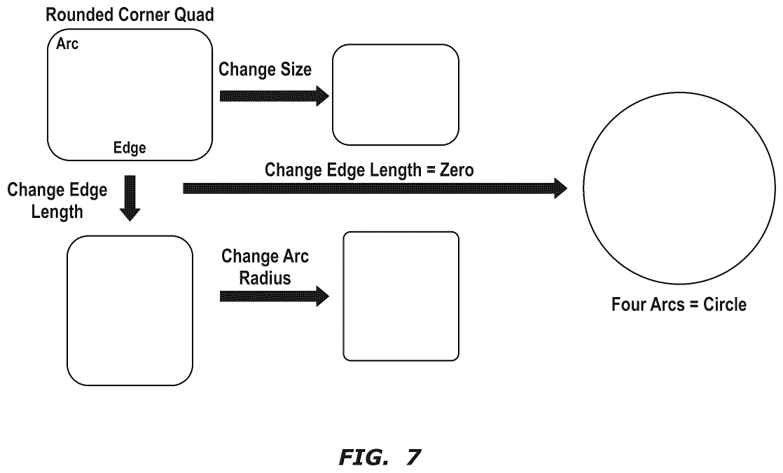

GEM element shapes utilized thus far are quadrilaterals, hexahedrons, and circles. Element shapes can be controlled through the lengths of the sides and the radius of the arcs as illustrated in FIG. 7 for quadrilaterals. GEM elements can have an aspect ratio greater than one with more natural bulking and inter-particle friction. GEM element contact detection, restorative forces, and explosive loading can be modeled utilizing the Noble-Abel equation of state.

### Energy Partitioning Between Brisance, Fragmentation And Heave

For the purposes of modeling the work done to move the burden, the adiabat of the explosive and the available heave work can be calculated. In order to mechanistically model the ability of explosives to heave rock, the following may be used. A mechanistic model, which of necessity contains several simplifying assumptions, for example regarding the distribution of sizes and shapes of the fragments to be moved by the product gases. The properties of rock, which are sometimes known approximately but often need to be inferred for the generic rock type. Thus, rock to be blasted is often described as hard, medium or soft, and homogenous, jointed or heavily jointed. A realistic description of the blast including variations in hole placement and depth and variations in explosives quantity and quality. EOS for the explosive that describes the detonation and explosion state pressures, the detonation velocity, and the decrease in gas pressure as the gases expand (the adiabat). In view of the above factors, approximate descriptions of the explosive may be adequate.

For the modeling of heave, the adiabat may have the following attributes. The adiabat may cover the entire expansion from explosion state to atmospheric pressure. The adiabat may be based on data available for commercial explosives. The adiabat may reduce to the ideal gas equation at lower pressures. The adiabat may have the calculated total available work to equal the heat of reaction (at least for non-aluminized explosives).

Some embodiments may use the following equations to model detonation properties. These calibrated analytical equations for detonation pressure and velocity may be based on the density, the calculated heat of reaction, and a simple version of the product gas mix for the explosive.

P_{cj}=15.58φρ₀² Equation 2
Where:
is the cj pressure in kbars;
ρₒ is the initial or loaded density of the explosive in gram per cubic centimeter;
cj designates the chapman-Jouget state which is the pressure and volume states of the explosive gases immediately following detonation; and
φ=NM1/2Q1/2
Where:
N is the number of moles of gaseous detonation products per gram;
M is the average molecular weight of the gas in grams; and
Q is the chemical energy of the detonation reaction (−ΔH°) in cal/g.

For Q, the change in heat of formation (−ΔHf°) may be used. For oxygen balanced explosives, M=1/N, but the equations for N and M above have the result that M≠1/N for oxygen negative explosives.

In some embodiments, the EOS has the following form.

P(V−b)=nRT Equation 3
Where:
P is the hydrostatic pressure in Pa;
V is the specific volume of the gaseous products in m3/kg;
b is the covolume, a constant, in m3/kg;
n is the number of moles of gaseous product in moles/kg;
R is the universal gas constant=8.314 J/mole/K; and
T is the temperature of the gas in K.

This EOS has the desirable property that along the entire adiabat.

P(V-b)γ=constant=k Equation 4
Where:
Y is the ratio of specific heats=Cp/Cv, behaving ideally; and
k is a constant evaluated for known values of P, V, b and γ.

For an adiabatic process, the work done by the product gases may be equal to the change in internal energy Q:

W=∫Pdv=∫CᵥdT= Q Equation 5

From these 2 equations it can be shown that:

$$b = \frac{{P}_{e} {V}_{e} - {P}_{f} {V}_{f} - Q ( γ - 1 )}{{P}_{e} - {P}_{f}} \qquad Equation 6$$

$${V}_{f} = {( \frac{{P}_{e}}{{P}_{f}} )}^{\frac{1}{γ}} ( {V}_{e} - b ) + b \qquad Equation 7$$

Where subscripts e and f refer to the explosion state (when the product gases have the same density as the unreacted explosive), and the final state at atmospheric. These simultaneous equations in b and V_{f} can be solved by iteration.

For more accurate simulations, explosive energy partitioning between brisance and heave may be applied. Brisance energy being that which expands the blasthole and propagates shock/stress waves into the rock producing the majority of the fragmentation. Heave energy is that which remains in the explosive gas products in the form of pressure and heat. This remaining gas energy moves the rock resulting in heave or throw.

The energy of the explosive may be partitioned into total available work and brisance energy, as described below. Half of the shock and elastic strain energies may be directed through the burden towards the free face, while the other half disappears into the rock behind the blast. Also, some of the energy lost in compressing the crushed rock may be returned to the gas as the pressure drops. For these reasons the following approximation may be adopted for heave work:

Wₕₑₐᵥₑ=Wₜₒₜₐₗ½W_{brisance} Equation 8

As shown in Equation 8, the heave work may be the total available work minus a portion of the brisance energy. In some embodiments, the amount of brisance work that is subtracted from the total available work to determine the heave work may be half as described Equation 8 above. In other embodiments, the fraction of the brisance work may that is subtracted from the total available work to determine the heave work may be different. For instance, in some embodiments, the parameter reducing the brisance work may be in the range of 0.1 to 0.9. In some embodiments, the parameter may be adjustable based on environmental factors. For example, for different rock hardness values, a different fraction of the brisance energy may be removed from the total available work to calculate the heave work.

As shown in Equation 8, in some embodiments the heave energy of the explosive may be partitioned into total available work, W, and half the Brisance energy. This reduction in the heave energy may be representative of a scenario where half of the energy radiates toward the free face where movement can occur. Some explosives of interest have been characterized in the EOS described above. The starting borehole pressure for the heave simulation may be calculated utilizing the adiabat based on the EOS. It may be unique for each explosive/rock combination.

Brisance may comprise the stage during which the rock surrounding the hole may be crushed, and a shock wave is released into the rock, leaving that rock in a state of elastic strain. Brisance refers to the degree of crushing and elastic shock exerted by the explosive. It radiates uniformly in all directions from the blasthole.

Since generation and propagation of (mostly) radial fractures is slow compared to the timescale of the shock, this end-of-shock state is called and treated as quasi-static. The radius of the hole increases from R₀ to Rₑₗ (“elastic” radius), the gas volume increases to V_{el,g} and the pressure drops to Pₑₗ (above) along the adiabat.

This process may be considered below in three steps. Firstly, some of the rock surrounding the hole, failing under compression and shear, is crushed. Secondly, this annulus of crushed rock is compressed thereby increasing the space available for the product gases, and thirdly the rock beyond the crushed zone is left (by the passage of the shock wave) in a state of elastic strain. This strain further increases the volume available for the product gases.

One method of calculating the crushed zone surrounding a borehole comprises the following calculation.

R_{cr}/R₀=k·(P/σc)0.4 Equation 9
Where:
R_{cr} is the radius of the hole+crushed zone;
R₀ is the initial hole radius;
k is a constant, in SI units k˜0.55;
P is the pressure in the hole; and
σ_{c} the dynamic uniaxial compressive strength (UCS) of the rock.

Note that for the rock to be crushed R_{cr}/R₀>1. In general, R_{cr}/R₀>1. .

In some embodiments, the value of k may be set by making R_{cr} only slightly bigger than R₀ for ANFO in very hard rock, from which it was found that k=0.55. As an integral part of the crushing process, the crushed rock is also compressed. The volume of the uncompressed crushed rock V_{cr,u} may be known from the size of the annulus R_{cr}-R₀ per unit length of borehole. The change in volume due to compression is approximated by;

ΔV_{cr}=V_{cr,u}·(P/K) Equation 10
Where:
P is the borehole pressure on the explosive gas adiabat; and
K is the bulk modulus of compressibility of the rock.

While the rock is being crushed and compressed, a shock wave is being generated that propagates away from the hole. This complex dynamic process may be approximated for modeling. It may be assumed that the rock surrounding the crush zone behaves elastically. Using a quasi-static assumption, this elastic compression can be evaluated using the widely available equations for a thick-walled cylinder. The relevant internal pressure is the borehole pressure along the adiabat. The outer radius of the thick-walled cylinder may be set to infinite. (Using an external radius equal to the burden makes a negligible difference to the results). The change in internal volume of the cylinder due to the elastic compression of the very thick cylinder wall is then given by the following equation.

V/Vi=((a+da)/a)²=[(P(1+v)/E+1]²
Where:
V is the expanded internal volume;
Vᵢ is the initial volume of the cylinder (before internal pressure is applied);
a is the cylinder radius;
da is the change in radius;
P is the pressure on the adiabat;
v is Poisson's ratio; and
E is Young's modulus of the rock.

These expressions give the functional relationship between the volume of the borehole as a result of both the crushing and compression of the rock around the hole, and the final state of elastic compression of the rock after the passage of the shock wave. Simultaneous solution of these equations with the P(V) equation of the adiabat gives the pressure at the end of Brisance, and from that, the work done between the CJ and Brisance states.

This annulus of crushed rock between R₀ and R_{cr} is compressed by the product gases according to the dynamic bulk modulus of the rock and the gas pressure. The final step in the Brisance algorithm may be to calculate the state of the borehole after passage of the shock wave. The rock surrounding the hole may be treated as elastic and the burden as a thick-walled cylinder, allowing the further change in hole radius to be calculated. Brisance work may be determined by:

$$\begin{matrix}{W}_{brisance} = \int PdV from the CJ to end - of - shock state \\ = elastic {(}_{el} ) state \\ = ( {P}_{cj} ( {V}_{cj} - b ) - {P}_{el} ( {V}_{el , g} - b ) ) / ( γ - 1 )\end{matrix}$$

Where:
cj designates the chapman-Jouget state which is the pressure and volume states of the explosive gases immediately following detonation;
P_{cj}=cj Pressure,
V_{cj}=cj volume,
b=Covolume from the Noble Abel equation of state for a specific explosive;
Pₑₗ=Elastic state pressure,
V_{el,g}=Elastic state volume; and
γ=Heat capacity ratio Cp/Cv.

Finally, in order to provide a Heave adiabat for use in GEM, a new initial heave state (h) may be calculated such that:

Wₕₑₐᵥₑ=[(Pₕ(Vₕ−b)−P_{f}(V_{f}−b)]/(γ−1)=Wₜₒₜₐₗ−½W_{brisance}
Where:
Pₕ=Heave state initial pressure;
Vₕ=Heave state initial volume; and
P_{f} and V_{f} are the final heave state pressure and volume.

The algorithms of simulations for rock movement may use initial and final states of the heave process and the P(V) adiabat that links these 2 states. To use Wₕₑₐᵥₑ=Wₜₒₜₐₗ−½W_{brisance}, a new artificial state may be created along the adiabat such that the energy between this state and the CJ state(or, equally, between this state and the Brisance state) is equal to ½W_{brisance.}This state may be called the initial heave state, characterized by Pᵢₕ. Example values of Pᵢₕ for different explosive/rock combinations is shown in FIG. 19.

For the modeling of fragmentation and heave, the adiabat may be based on data that is available for commercial explosives, using Noble-Abel EOS. Embodiments may produce cast behavior predictions consistent with the explosive formulation.

Implementation of explosive gas element loading may include the following. Loads from explosive gas products may be computed considering the expansion of the blast hole and diffusion of the gas within the fractured rock. Pressure in the gas may be computed using the adiabat. The fracture induced permeability of the rock may increase as the blasthole expands.

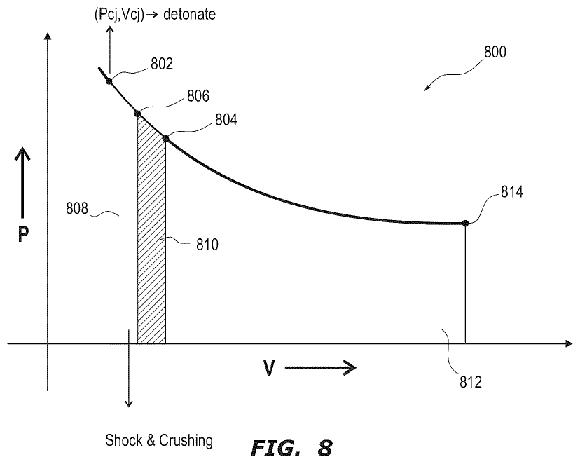

FIG. 8 is a graph of an example adiabat 800 for an explosion. The adiabat 800 shows a pressure and volume states of the explosion. The pressure in the gas may be computed using the EOS described above based on a current specific volume. The total available work 812 for the explosion may include the area under the adiabat 800 from the detonation point 802 (e.g., P _{cj}, V_{cj}) until the detonation reaches atmospheric pressure (e.g., end point 814).

A brisance point 804 (P_{Brisance}, V_{Brisance}) may define an end to the brisance state. The area under the adiabat 800 between the detonation point 802 and the brisance point 804 is the brisance work from the explosion. Not all the work done during the brisance state (e.g., before the brisance point 804) will contribute to heave of the rocks. Brisance energy expands the blasthole and propagates shock/stress waves into the rock producing the majority of the fragmentation. Some of this brisance energy will contribute to heave of the rocks.

As shown, the brisance work is divided into a first section 808 and a second section 810. In some embodiments, the work done in the first section 808 may be half of the brisance work, and the work done during the second section 810 may also be half of the brisance work. To determine Wₕₑₐᵥₑ=Wₜₒₜₐₗ−½W_{brisance}, an initial heave state 806 (i.e. Pin) is indicated along the adiabat 800. In some embodiments, the initial heave state 806 may be positioned such that the energy between the initial heave state 806 and the detonation point 802 (or, equally, between this state and the brisance point 804) is equal to ½W_{brisance}. The W_{brisance} equal to the work between the detonation point 802 and the brisance point 804 (e.g., the first section 808 and the second section 810). In other embodiments, the first section 808 and the second section 810 may be different. For example, the initial heave state 806 may positioned such that the energy between the initial heave state 806 and the detonation point 802 is somewhere in the range between 0.1*W_{brisance} to 0.9*W_{brisance} (i.e., 10% to 90% of W_{brisance}). In another example, the initial heave state 806 may positioned such that the energy between the initial heave state 806 and the detonation point 802 is somewhere in the range between 0.4*W_{brisance} to 0.6*W_{brisance} (i.e., 40% to 60% of W_{brisance}).

The first section 808 may be considered the energy used to shock/stress waves into the rock producing the majority of the fragmentation before heave of the rocks begins. Once the initial heave state 806 is reached, the pressure between the initial heave state 806 and the end point 814 may be used to calculate heave of the rocks in a simulation. Heave energy (e.g., total available work 812 minus the first section 808) is that which remains in the explosive gas products in the form of pressure and heat. This remaining gas energy moves the rock resulting in heave or throw. Accordingly, systems may use the work between the initial heave state 806 and the end point 814 to simulate heave.

By using a portion of the brisance energy in heave calculations, a simulation may yield more accurate results. Accordingly, Wₕₑₐᵥₑ=Wₜₒₜₐₗ−Y*W_{brisance}, where Y is a variable that is less than one. In some embodiments, half of the brisance work may be removed from the total available work to determine the heave work. In some embodiments, the portion of the brisance work removed from the total available work is between 40% to 60% of the brisance work. In some embodiments, the portion of the brisance work removed from the total available work is between 10% to 90% of the brisance work.

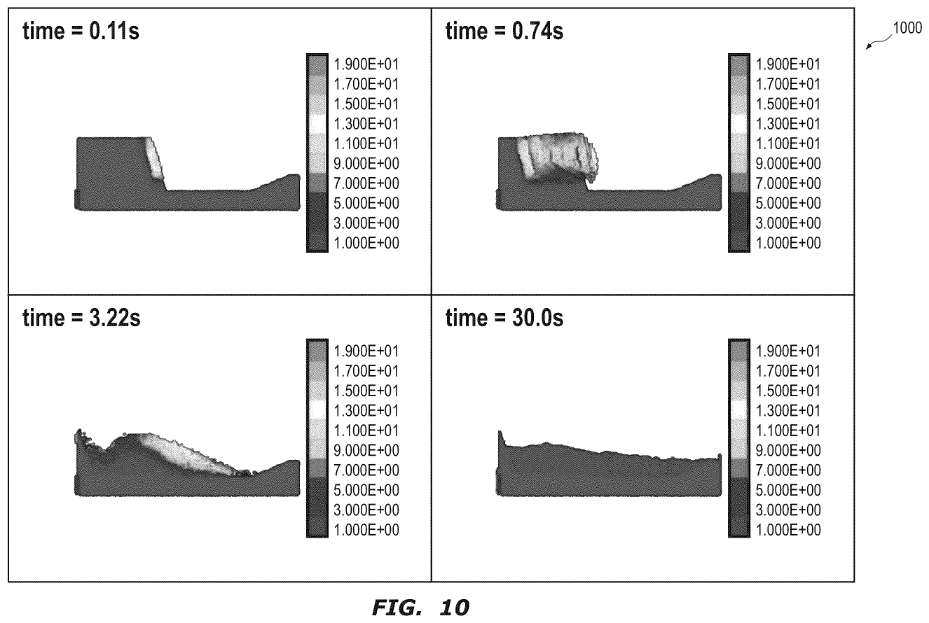

Using less than the total brisance work may arise from two considerations. First, the dynamic shock energy may impart forward momentum to the burden rock, which (in 2-D) is half the rock affected by the shock wave, and second, some of the work done in elastic compression of the rock outside the crushed annulus may be recovered as this rock relaxes when the pressure drops. The modeling of heave described in FIGS. 10-23 illustrate the consequences of the using total work minus a portion of brisance work when determining heave work.

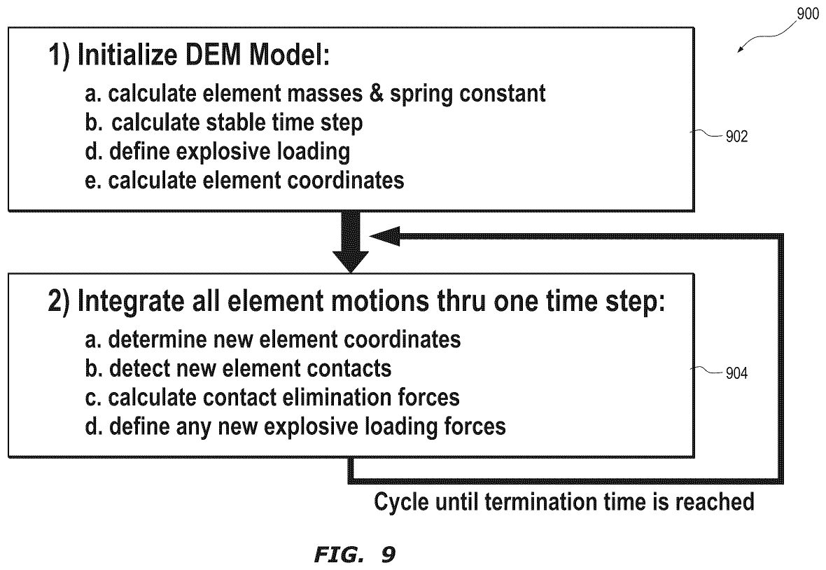

FIG. 9 illustrates a flow chart for a discrete element method 900 in accordance with some embodiments. The method 900 may initialize 902 a discrete element model. Initializing a model may include generating, creating, or starting a model for a simulation. Initializing may include generating details regarding the model, determining a starting point for the simulation, determining element shapes/sizes, etc. When initializing the model, the method 900 may calculate masses and spring constants, calculate a stable time step, define the explosive loading, and calculate element coordinates.

The method 900 may 904 integrate element motions thru each time steps. For each time step the method 900 may determine new element coordinates, detect new element contacts, calculate contact elimination forces, and define any new explosive loading forces. Movement of elements may begin after the initial heave state is reached. The heave energy (e.g., Wₕₑₐᵥₑ=Wₜₒₜₐₗ=W_{brisance}) may be used as a force that moves the elements. The method 900 cycles through the time steps until a termination time is reached.

In some embodiments, energy partitioning may be used in a method for loading a blasthole. For example, a method may include determining an explosive loading profile for a blasthole to achieve a desired outcome, and loading the blasthole with explosives according to the loading profile. Determining an explosive loading profile may include simulating a blast by determining a total available work from a hypothetical detonation of an explosive and partitioning the total available work by removing a portion of brisance work from the total available work to generate heave work, such that simulating a blast is based on the heave work, and selecting the explosive to achieve the simulated blast that approximates the desired outcome.

In some embodiments, the brisance work is work performed between the hypothetical detonation and a brisance point of the explosive. In some embodiments, selecting the explosive comprises identifying a type of explosive and/or an energy output of an explosive. In some embodiments, the type of explosive is selected from at least one of: an emulsion explosive, ammonium nitrate prill and fuel oil, a water gel-based explosive, or blends and mixtures thereof. In some embodiments, the energy output of an explosive is selected from at least one of: a density of an explosive, or a volume of an explosive. In some embodiments, selecting the explosive comprises selecting multiple energy outputs of an explosive in different portions of the blasthole. In some embodiments, selecting the explosive comprises selecting multiple types of explosives in different portions of the blasthole.

FIGS. 10-12 illustrate results of a first blast simulation using GEM and energy partitioning. FIG. 10 illustrates four time snapshots of a GEM simulation of a blast utilizing circular elements as well as the explosive energy partitioning technique described above. The energy partitioning technique may lead to more accurate simulations.

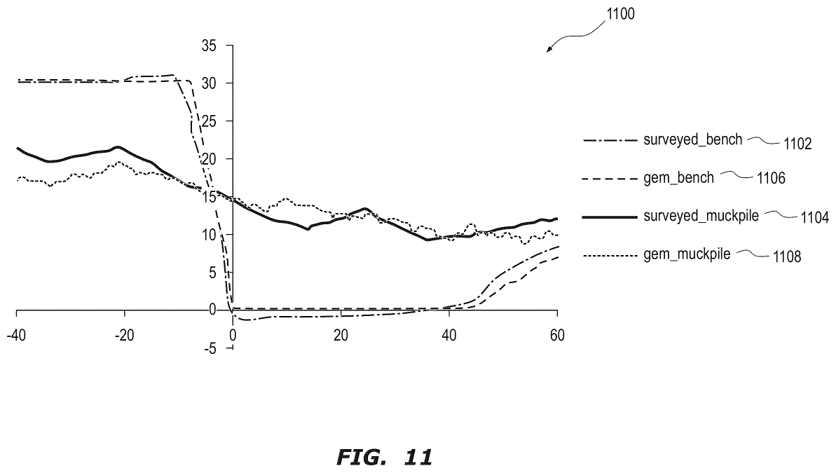

For example, FIG. 11 illustrates a chart 1100 comparing the surveyed bench 1102 and muck pile profile 1104 to the modeled bench 1106 and predicted muck pile profile 1108. The predicted muck pile profile 1108 was generated using GEM and energy partitioning (e.g., Wₕₑₐᵥₑ=Wₜₒₜₐₗ−½W_{brisance}). The cast line, which is the angle of repose of the muck was assumed to be 45 degrees. The muck profile as well as the calculated percent cast of 45.6%, compared with measured of 45%, adds credence to the reliability of energy partitioning and GEM as a blast movement predictive tool. An important aspect of these simulations is the inclusion energy partitioning.

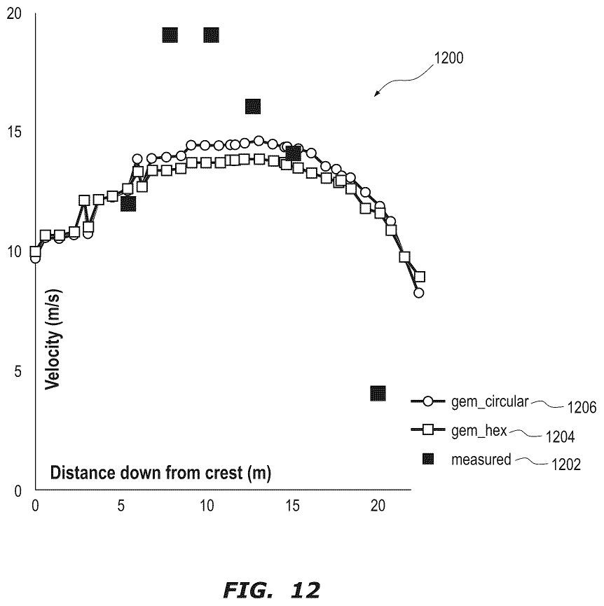

Face velocity is an important metric for understanding, predicting, and improving cast blasting. Face velocities were measured during this blast utilizing rock filled orange painted boxes hung down the face. FIG. 12 illustrates a graph 1200 showing a comparison between the measured face velocity 1202 and the GEM predicted face velocities simulated with circular and hexahedral elements. High-Speed camera measured velocities straddle the predicted velocities (e.g., circular simulated velocity 1206 and hex simulated velocity 1204) with three of the measured velocities being close to the predicted. However, two of the measured velocities are significantly higher than the mean and one is significantly lower. Examination of the bench face in both the GEM modeling and the blast photo leads to a viable explanation. The figure shows substantial bowing of the face early in the blast. FIG. 10, at time 0.74 seconds illustrates bowing of the face but what seems to be less dramatic than that of the explosion. A possibility for the differences in the velocity behavior is that the GEM elements in hexagonal close-pack configuration resists horizontal slippage more than what is occurring in the layered shale being blasted.

Face velocities predicted by GEM roughly match the face curvature as measured. The three highest face velocity measurements would not produce the face curvature and are believed to be erroneous. The explosive shock impacting the free face may launch the targets at a higher velocity than the free face.

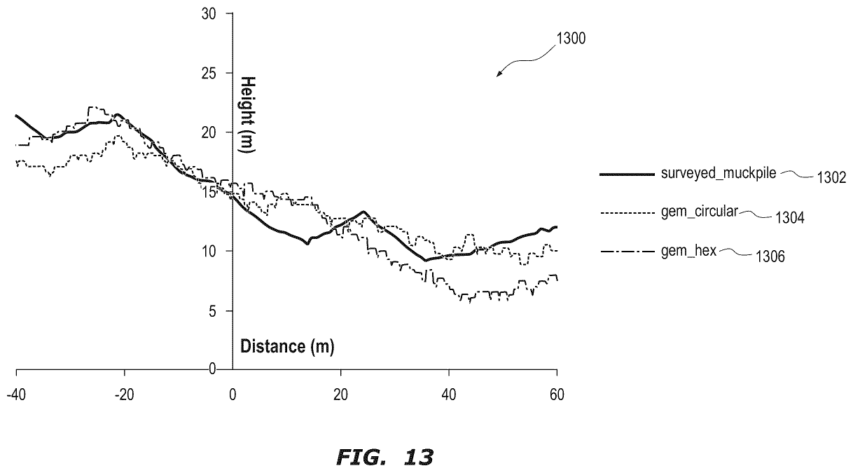

FIG. 13 illustrates the results 1300 of a second blast modeled with both circular and hexagonal elements and compared with a surveyed muck pile 1302. The hex elements that result in the hex profile 1306 do not move as easily as circular elements that result in the circular profile 1304 which results in a higher muck pile in the back of the blast and lower in the front. Another way to describe the behavior is that the center-of-gravity of the muck pile has moved less for the hexagonal elements.

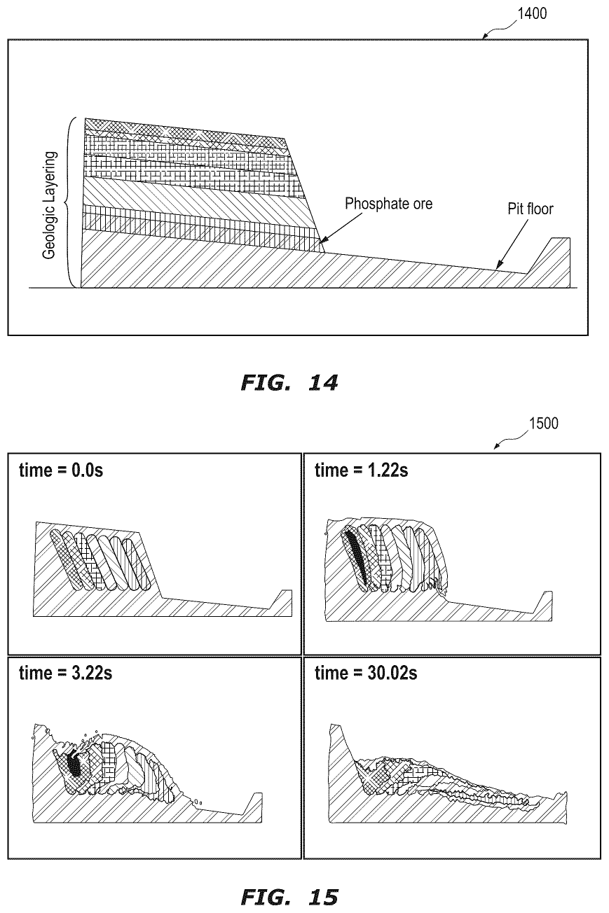

Another example of the corrective impact of this new energy partitioning method is illustrated in FIG. 14 and FIG. 15. Heave from this blast was previously under predicted as42% but the current version of GEM with energy partitioning is 44%. FIG. 14 illustrates a model 1400 using GEM elements in accordance with some embodiments. FIG. 15 illustrates four timestamps 1500 of a simulation of the model in FIG. 14 using energy partitioning in accordance with some embodiments.

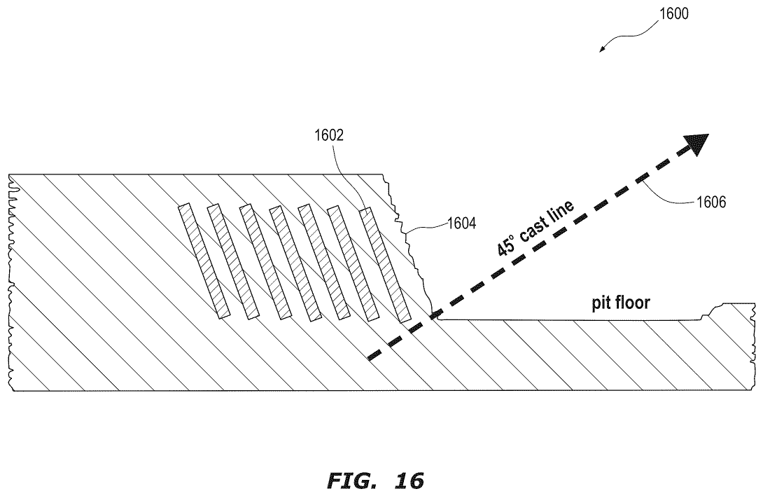

FIG. 16 illustrates a coal mine model 1600 in accordance with some embodiments. The model 1600 illustrates a bench 1604 and a series of blastholes 1602. Since GEM predicts rock motion, and heave is significant in cast blasting, a generic cast blast was used for a simulation. The results of the simulation for different cases is illustrated in FIGS. 17-23. Unless otherwise stated, the bench height of the bench 1604 was set to 40 m (131 ft), the hole angle of the blastholes 1602 was set to 20°, the hole diameter was set to 270 mm (105/8 inches), and the powder factor was set to 0.693-0.695 kg/m³ (0.85 cu yd/lb). The percentage of cast was calculated from the volume of rock beyond the 45° cast line 1606.

The available work for heaving the rock depends (via partition of energy) on both the explosive and the rock. This approach should give a better understanding of heave than the simple use of powder factor combined with Heat of Reaction or Relative Weight Strength (RWS). Four different explosives were used to simulate blasts of the model 1600 in FIG. 16. FIG. 17 illustrates a table 1700 of the four different explosives. The explosives used for simulation include ANFO Emulsion, 50/50 blend, and a non-ideal blend.

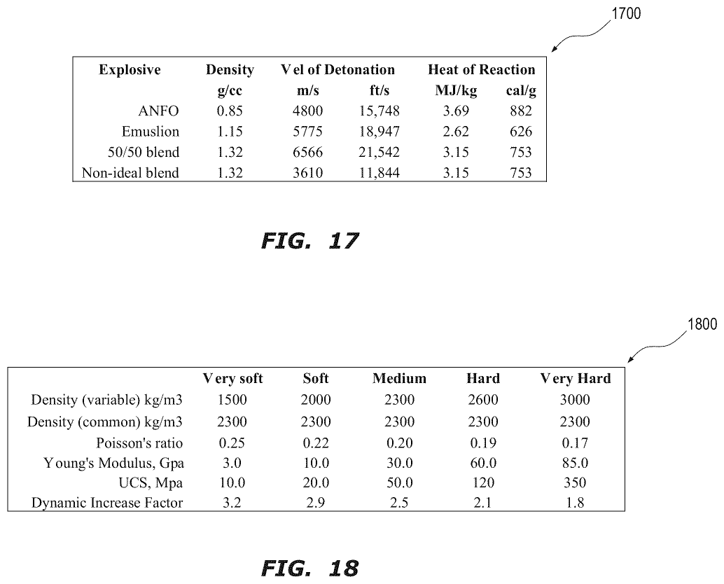

FIG. 18 shows a table 1800 that includes generic rock types used for the simulation of the model 1600 of FIG. 16. In table 1800, two densities are shown for each rock hardness. The variable density is generic for the rock types; the common density was used in some runs of the simulation to eliminate the effect of rock density on percent cast. The UCS variable stands for Uniaxial Compressive Strength. Since blasting has very high strain rates, and since most rock properties are static values, a Dynamic Increase Factor (DIF) was used for the simulations. Both the Young's modulus and UCS in table 1800 were multiplied by the DIF before use in the Brisance calculations for the simulations.

For most cases, two extreme rock types from this table were used in the test simulations for model 1600: very soft rock and very hard rock. The four explosive types and two extreme rock types result in eight main cases considered, as shown in table 1900 of FIG. 19.

FIG. 19 illustrates a table 1900 with example input variables for the simulation calculations for the model 1600 in FIG. 16 in accordance with some embodiments. Burdens and spacings as shown in table 1900 were chosen to achieve a constant powder factor of about 0.694 kg/m³. The values of Pᵢₕ, W_{brisance} and Wₕₑₐᵥₑ were calculated as described previously. This table shows that the work of Brisance (crushing and shock) varies from 6% to 56% of the total available work; significant work is done by the explosive in soft rock in the Brisance stage, leaving less energy available for heave.

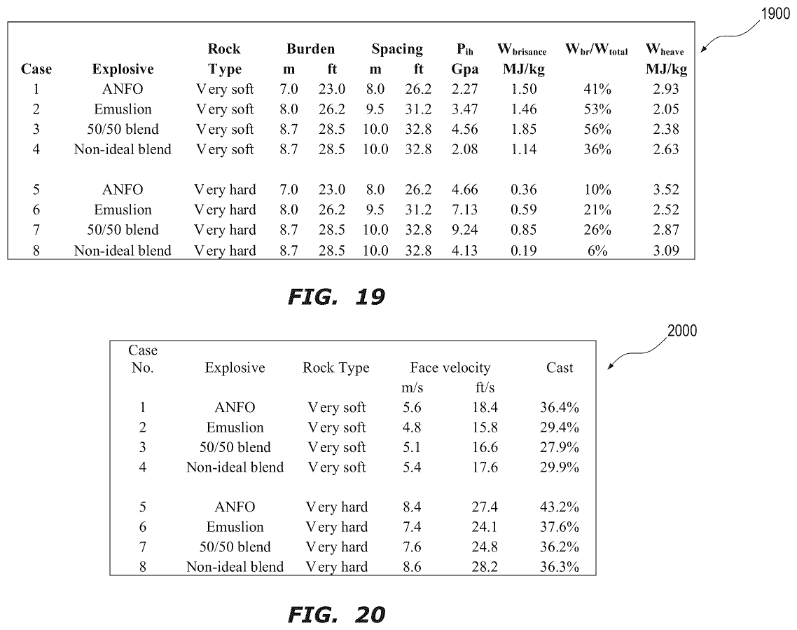

The results of the simulations for model 1600 with inputs from table 1900 are discussed with reference to FIGS. 20-23. The simulations were performed using GEM and energy partitioning. These results compare heave for the various explosives in two different rock types. FIG. 20 illustrates a table 2000 of the calculated heave for four explosives in two rock types. As shown, ANFO has the highest face velocity and the best percent cast for both very soft and very hard rock.

In soft rock (at the same powder factor), there may be little difference in percent cast between the emulsion and a 50/50 Heavy ANFO (see cases 2, 3, and 4 of table 2000). In the illustrated embodiment, the percent cast for the emulsion is better than that for the Heavy ANFO (at the same powder factor) despite the better RWS of the blend. The cast results in table 2000 are illustrated in FIG. 21. FIG. 21 illustrates a graph 2100 charting the effects of explosive and rock on cast. The points on the graph 2100 are from table 2000 of FIG. 20. The non-ideal blend gives a percent cast only 2% points better than the same explosive detonating ideally, even though the Brisance work (W_{brisance}) for these 2 cases is 1.14 vs 1.85 MJ/kg. (See cases 3 and 4 in table 1900). In other words, when a Heavy ANFO detonates at low velocity of detonation and the Brisance energy is reduced by about 40%, there is only a slight improvement in heave as measured by percent cast.

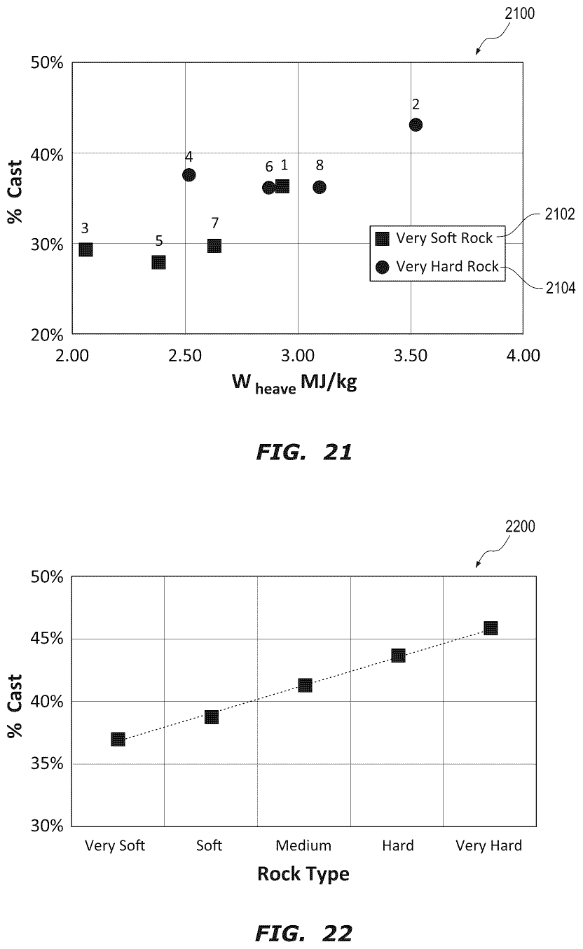

Table 2000 and graph 2100 also show that face velocities and percent cast are greater in very hard rock 2104 than in very soft rock 2102, for each of the four explosives. This is further illustrated in FIG. 22 for the five rock types in table 1800 of FIG. 18. FIG. 22 illustrates a graph 2200 showing the effect that rock type has on percent cast for ANFO. As shown, the cast is greater in hard rocks than soft rocks. This may be because less energy is lost to the brisance processes of crushing and shock.

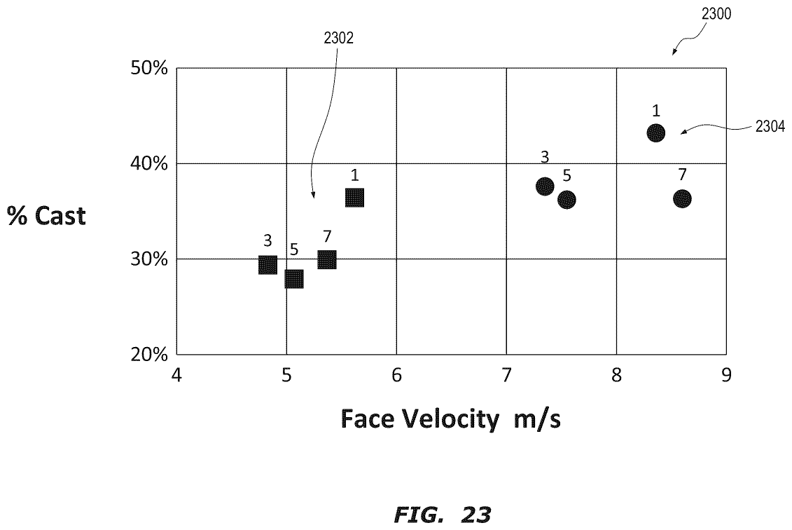

FIG. 23 illustrates a graph 2300 of percent cast versus face velocity for two rock types (i.e., very hard rock 2304 and very soft rock 2302). The values for the points charted are from table 2000 of FIG. 20. As shown, face velocity is generally higher for the harder rocks, but within each rock type, face velocity may not be a good predictor of % cast, as shown in graph 2300.

### EXAMPLES

The following examples pertain to specific embodiments and point out specific features, elements, or actions that can be used or otherwise combined in achieving such embodiments.

Example 1. A method for simulating an explosive blast, the method comprising: initializing a model of a blast site comprising a plurality of blastholes; identifying an explosive to be used for a simulated blast of the model; determining a total available work from a detonation of the explosive; partitioning the total available work by removing a portion of brisance work from the total available work to generate heave work, wherein the brisance work is work performed between the detonation and a brisance point of the explosive; and simulating the detonation of explosive based on the heave work.

Example 2. The method of example 1, wherein the heave work is used to determine heave of elements of the model.

Example 3. The method of example 1 or example 2, further comprising displaying the simulated blast and a resulting muck pile that results from the heave work.

Example 4. The method of any one of examples 1-3, further comprising determining an initial heave state between the detonation and the brisance point, wherein the initial heave state is a point at which a pressure from the detonation of the explosive begins to move elements of the model.

Example 5. The method of any one of examples 1-4, wherein the portion of the brisance work removed from the total available work is between 10% to 90% of the brisance work.

Example 6. The method of any one of examples 1-4, wherein the portion of the brisance work removed from the total available work is between 40% to 60% of the brisance work.

Example 7. The method of any one of examples 1-4, wherein the portion of the brisance work removed from is half of the brisance work.

Example 8. The method of any one of examples 1-7, wherein the model comprises a plurality of elements, and wherein simulating the detonation comprises determining movement of the elements based on the heave work.

Example 9. A computing apparatus comprising: a processor; and a memory storing instructions that, when executed by the processor, configure the apparatus to: initialize a model of a blast site comprising a plurality of blastholes; identify an explosive to be used for a simulated blast of the model; determine a total available work from a detonation of the explosive; partition the total available work by removing a portion of brisance work from the total available work to generate heave work, wherein the brisance work is work performed between the detonation and a brisance point of the explosive; and simulate the detonation of explosive based on the heave work.

Example 10. The computing apparatus of example 9, wherein the heave work is used to determine heave of elements of the model.

Example 11. The computing apparatus of example 9 or example 10, wherein the instructions further configure the apparatus to display the simulated blast and a resulting muck pile that results from the heave work.

Example 12. The computing apparatus of any one of examples 9-11, wherein the instructions further configure the apparatus to determine an initial heave state between the detonation and the brisance point, wherein the initial heave state is a point at which a pressure from the detonation of the explosive begins to move elements of the model.

Example 13. The computing apparatus of any one of examples 9-12, wherein the portion of the brisance work removed from the total available work is between 10% to 90% of the brisance work.

Example 14. The computing apparatus of any one of examples 9-12, wherein the portion of the brisance work removed from the total available work is between 40% to 60% of the brisance work.

Example 15. The computing apparatus of any one of examples 9-12, wherein the portion of the brisance work removed from is half of the brisance work.

Example 16. The computing apparatus of any one of examples 9-15, wherein the model comprises a plurality of elements, and wherein simulating the detonation comprises determine movement of the elements based on the heave work.

Example 17. A non-transitory computer-readable storage medium, the computer-readable storage medium including instructions that when executed by a computer, cause the computer to: initialize a model of a blast site comprising a plurality of blastholes; identify an explosive to be used for a simulated blast of the model; determine a total available work from a detonation of the explosive; partition the total available work by removing a portion of brisance work from the total available work to generate heave work, wherein the brisance work is work performed between the detonation and a brisance point of the explosive; and simulate the detonation of explosive based on the heave work.

Example 18. The computer-readable storage medium of example 17, wherein the heave work is used to determine heave of elements of the model.

Example 19. The computer-readable storage medium of example 17 or example 18, wherein the instructions further configure the computer to display the simulated blast and a resulting muck pile that results from the heave work.

Example 20. The computer-readable storage medium of any one of examples 17-19, wherein the instructions further configure the computer to determine an initial heave state between the detonation and the brisance point, wherein the initial heave state is a point at which a pressure from the detonation of the explosive begins to move elements of the model.

Example 21. The computer-readable storage medium of any one of examples 17-20, wherein the portion of the brisance work removed from the total available work is between 10% to 90% of the brisance work.

Example 22. The computer-readable storage medium of any one of examples 17-20, wherein the portion of the brisance work removed from the total available work is between 40% to 60% of the brisance work.

Example 23. The computer-readable storage medium of any one of examples 17-20, wherein the portion of the brisance work removed from is half of the brisance work.

Example 24. The computer-readable storage medium of any one of examples 17-23, wherein the model comprises a plurality of elements, and wherein simulating the detonation comprises determine movement of the elements based on the heave work.

Example 25. A method of loading a blasthole, the method comprising: determining an explosive loading profile for a blasthole to achieve a desired outcome; and loading the blasthole with explosives according to the loading profile; wherein determining an explosive loading profile comprises: simulating a blast by determining a total available work from a hypothetical detonation of an explosive and partitioning the total available work by removing a portion of brisance work from the total available work to generate heave work, such that simulating a blast is based on the heave work; and selecting the explosive to achieve the simulated blast that approximates the desired outcome.

Example 26. The method of example 25, wherein the brisance work is work performed between the hypothetical detonation and a brisance point of the explosive.

Example 27. The method of example 25 or example 26, wherein selecting the explosive comprises identifying a type of explosive and/or an energy output of an explosive.

Example 28. The method of any one of example 27, wherein the type of explosive is selected from at least one of: an emulsion explosive, ammonium nitrate prill and fuel oil, a water gel-based explosive, or blends and mixtures thereof.

Example 29. The method of any one of example 27 or example 28, wherein the energy output of an explosive is selected from at least one of: a density of an explosive, or a volume of an explosive.

Example 30. The method of any one of examples 25-29, wherein selecting the explosive comprises selecting multiple energy outputs of an explosive in different portions of the blasthole.

Example 31. The method of any one of examples 25-30, wherein selecting the explosive comprises selecting multiple types of explosives in different portions of the blasthole.

Example 32. The method of any one of examples 25-31, wherein the heave work is used to determine heave of elements of a model.

Example 33. The method of any one of examples 25-32, further comprising displaying the simulated blast and a resulting muck pile that results from the heave work.

Example 34. The method of any one of examples 25-33, further comprising determining an initial heave state between the hypothetical detonation and a brisance point, wherein the initial heave state is a point at which a pressure from the hypothetical detonation of the explosive begins to move elements of a model.

Example 35. The method of any one of examples 25-34, wherein the portion of the brisance work removed from the total available work is between 10% to 90% of the brisance work.

Example 36. The method of any one of examples 25-34, wherein the portion of the brisance work removed from the total available work is between 40% to 60% of the brisance work.

Example 37. The method of any one of examples 25-34, wherein the portion of the brisance work removed from is half of the brisance work.

Example 38. The method of any one of examples 25-37, wherein the model comprises a plurality of elements, and wherein simulating the hypothetical detonation comprises determine movement of the elements based on the heave work.

Embodiments herein provide GEM distinct element rock blasting heave modeling that includes energy partitioning. Embodiments herein may more accurately predict the amount of explosive energy that contributes to fragmentation and to heave. In some embodiments, the brisance work may be divided into fragmentation energy and heave energy. Getting the energy partitioned correctly may remove the need for user defined coupling factors that are adjusted for every blast model to match measured field blasting heave results.

Partition of energy concepts suggest that energy lost to Brisance may not be available for Heave. Brisance may be defined as the work done by the explosive in crushing of the rock surrounding the borehole, and generating the shock wave (which leaves the burden before burden motion begins). Some embodiments herein propose modeling of energy partition, namely that a portion (e.g., half) of the calculated brisance work contributes to heave while the other half does not contribute to rock motion.

The implementation of Partition of Energy concepts in GEM is shown not to create excessive dependence of the results on element size, suggesting that the blast loading on the rock is done in a way that is insensitive to the element size.

Reference throughout this specification to an “embodiment” means that a particular feature, structure, or characteristic described in connection with that embodiment is included in at least one embodiment. Thus, references to embodiments throughout this specification are not necessarily all referring to the same embodiment.

Similarly, it should be appreciated by one of skill in the art with the benefit of this disclosure that in the above description of embodiments, various features are sometimes grouped together in a single embodiment, figure, or description thereof for the purpose of streamlining the disclosure. This method of disclosure, however, is not to be interpreted as reflecting an intention that any claim requires more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

Recitation in the claims of the term “first” with respect to a feature or element does not necessarily imply the existence of a second or additional such feature or element. It will be apparent to those having skill in the art that changes may be made to the details of the above-described embodiments without departing from the underlying principles of the present disclosure.

1. A method for simulating an explosive blast, the method comprising:
initializing a model of a blast site comprising a plurality of blastholes;
identifying an explosive to be used for a simulated blast of the model;
determining a total available work from a detonation of the explosive;
partitioning the total available work by removing a portion of brisance work from the total available work to generate heave work, wherein the brisance work is work performed between the detonation and a brisance point of the explosive; and
simulating the detonation of explosive based on the heave work.

2. The method of claim 1, wherein the heave work is used to determine heave of elements of the model.

3. The method of claim 1, further comprising displaying the simulated blast and a resulting muck pile that results from the heave work.

4. The method of claim 1, further comprising determining an initial heave state between the detonation and the brisance point, wherein the initial heave state is a point at which a pressure from the detonation of the explosive begins to move elements of the model.

5. The method of claim 1, wherein the portion of the brisance work removed from the total available work is between 10% to 90% of the brisance work.

6. The method of claim 1, wherein the portion of the brisance work removed from the total available work is between 40% to 60% of the brisance work.

7. The method of claim 11, wherein the portion of the brisance work removed from is half of the brisance work.

8. The method of claim 1, wherein the model comprises a plurality of elements, and wherein simulating the detonation comprises determining movement of the elements based on the heave work.

9. A computing apparatus comprising:
a processor; and
a memory storing instructions that, when executed by the processor, configure the apparatus to:
initialize a model of a blast site comprising a plurality of blastholes;
identify an explosive to be used for a simulated blast of the model;
determine a total available work from a detonation of the explosive;
partition the total available work by removing a portion of brisance work from the total available work to generate heave work, wherein the brisance work is work performed between the detonation and a brisance point of the explosive; and
simulate the detonation of explosive based on the heave work.

10. (canceled)

11. (canceled)

12. The computing apparatus of claim 9, wherein the instructions further configure the apparatus to determine an initial heave state between the detonation and the brisance point, wherein the initial heave state is a point at which a pressure from the detonation of the explosive begins to move elements of the model.

13. The computing apparatus of claim 9, wherein the portion of the brisance work removed from the total available work is between 10% to 90% of the brisance work.

14. The computing apparatus of claim 9, wherein the portion of the brisance work removed from the total available work is between 40% to 60% of the brisance work.

15-24. (canceled)

25. A method of loading a blasthole, the method comprising:
determining an explosive loading profile for a blasthole to achieve a desired outcome; and
loading the blasthole with explosives according to the loading profile;
wherein determining an explosive loading profile comprises:
simulating a blast by determining a total available work from a hypothetical detonation of an explosive and partitioning the total available work by removing a portion of brisance work from the total available work to generate heave work, such that simulating a blast is based on the heave work; and
selecting the explosive to achieve the simulated blast that approximates the desired outcome.

26. (canceled)

27. The method of claim 25, wherein selecting the explosive comprises identifying a type of explosive and/or an energy output of an explosive.

28. The method of claim 27, wherein the type of explosive is selected from at least one of: an emulsion explosive, ammonium nitrate prill and fuel oil, a water gel-based explosive, or blends and mixtures thereof.

29. The method of claim 27, wherein the energy output of an explosive is selected from at least one of: a density of an explosive, or a volume of an explosive.

30. The method of claim 25, wherein selecting the explosive comprises selecting multiple energy outputs of an explosive in different portions of the blasthole.

31. The method of claim 25, wherein selecting the explosive comprises selecting multiple types of explosives in different portions of the blasthole.

32. (canceled)

33. The method of claim 25, further comprising displaying the simulated blast and a resulting muck pile that results from the heave work.

34. (canceled)

35. (canceled)

36. The method of claim 25, wherein the portion of the brisance work removed from the total available work is between 40% to 60% of the brisance work.

37. (canceled)

38. (canceled)
